(19) United States
(12) Patent Application Publication
(10) Pub. No.: US 2024/0178611 A1
(43) Pub. Date: May 30, 2024

(54) WEATHERPROOF COVER FOR RECEPTACLE IN SINGLE-GANG HOUSING

(71) Applicant: Hubbell Incorporated, Shelton, CT (US)

(72) Inventors: Victor Beristany, South Bend, IN (US); Krzysztof Korcz, Granger, IN (US); Krishna Patel, Granger, IN (US)

(21) Appl. No.: 18/519,812

(22) Filed: Nov. 27, 2023

Related U.S. Application Data
(60) Provisional application No. 63/428,582, filed on Nov. 29, 2022.

(51) Int. Cl. H01R 13/52; B65D 43/16

(52) U.S. Cl. CPC H01R 13/5213; B65D 43/165; B65D 2543/00203; H01R 25/006

(57) ABSTRACT

A cover assembly for a receptacle includes a base having a back wall and a plurality of sidewalls extending from the back wall. A central opening is provided in the back wall. The central opening corresponds in size to a single-gang receptacle housing. A receptacle is connected to the base. The receptacle has a front section with a plurality of outlets and a rear section extending through the central opening. The rear section includes a terminal for making an electrical connection to a power supply. A cover is connected to the base. The cover is pivotable between an open position providing access to the receptacle and a closed position enclosing the receptacle.

### RELATED APPLICATION(S)

This application is based on U.S. Provisional Application Ser. No. 63/428,582, filed Nov. 29, 2022 the disclosure of which is incorporated herein by reference in its entirety and to which priority is claimed.

### FIELD

Various exemplary embodiments relate to outdoor covers for electrical receptacles.

### BACKGROUND

Electrical receptacles can be mounted in various locations and positions depending on a particular application. Receptacles that are mounted outside and exposed to the weather require suitable shielding to protect the receptacle and electrical plugs and cords from the weather and particularly rain. Therefore, receptacle boxes mounted outside typically have one or more covers to close around the electrical device and the electrical cords.

Certain cover assemblies can be mounted in different orientations using a hinge member on two adjacent sides of a base and two adjacent sides of the cover. The base and cover can be oriented in the selected horizontal or vertical position and the appropriate members are coupled together. The hinge members that are not being used can be removed or are positioned to be inactive. These covers can also be adapted to allow for the cover to be closed around an electrical plug so that weatherproof protection can be provided while the receptacle is in use.

### SUMMARY

In certain configurations a cover assembly for a receptacle includes a base having a back wall and a plurality of sidewalls extending from the back wall. A central opening is provided in the back wall. The central opening corresponds in size to a single-gang receptacle housing. A receptacle is connected to the base. The receptacle has a front section with a plurality of outlets and a rear section extending through the central opening. The rear section includes a terminal for making an electrical connection to a power supply. A cover is connected to the base. The cover is pivotable between an open position providing access to the receptacle and a closed position enclosing the receptacle.

In certain configurations a cover assembly for a receptacle includes a base having a back wall and a plurality of sidewalls extending from the back wall. A central opening is provided in the back wall. The central opening corresponds in size to a single-gang receptacle housing. A receptacle is connected to the base. The receptacle has a front section with a multi-gang configuration and a rear section extending through the central opening. The rear section includes a terminal for making an electrical connection to a power supply. A cover is connected to the base. The cover is pivotable between an open position providing access to the receptacle and a closed position enclosing the receptacle.

In certain configurations a cover assembly for a receptacle includes a base having a back wall and a plurality of sidewalls extending from the back wall. A central opening is provided in the back wall. The central opening corresponds in size to a single-gang receptacle housing. At least one of the plurality of sidewalls includes a first passage. A gate is removably positioned in the first passage. A receptacle is connected to the base. The receptacle has a front section with a plurality of outlets and a rear section extending through the central opening. The rear section includes a terminal for making an electrical connection to a power supply. A cover is connected to the base. The cover is pivotable between an open position providing access to the receptacle and a closed position enclosing the receptacle.

### BRIEF DESCRIPTION OF THE DRAWINGS

The aspects and features of various exemplary embodiments will be more apparent from the description of those exemplary embodiments taken with reference to the accompanying drawings.

FIG. 1 is a perspective view of a cover assembly connected to a receptacle housing.

FIG. 2 is a front view of the cover assembly.

FIG. 3 is a front perspective view of a receptacle.

FIG. 4 is a rear perspective view of the receptacle of FIG. 3.

FIG. 5 is a front perspective view of a cover assembly with an alternative receptacle.

FIG. 6 is a front perspective view of the receptacle of FIG. 5.

FIG. 7 is a rear perspective view of the receptacle of FIG. 5.

### DETAILED DESCRIPTION OF EXEMPLARY EMBODIMENTS

Certain aspects described herein are directed to a receptacle cover assembly configured to connect to a single-gang receptacle housing and surrounding a receptacle having a plurality of outlets. The receptacle can have a multi-gang configuration in a front section while permitting connecting to the single-gang housing. The receptacle can have more than two outlet openings, and thus allow for more plug connections than typically associated with a single-gang housing. The cover assembly can provide a weatherproof, in-use cover for the receptacle.

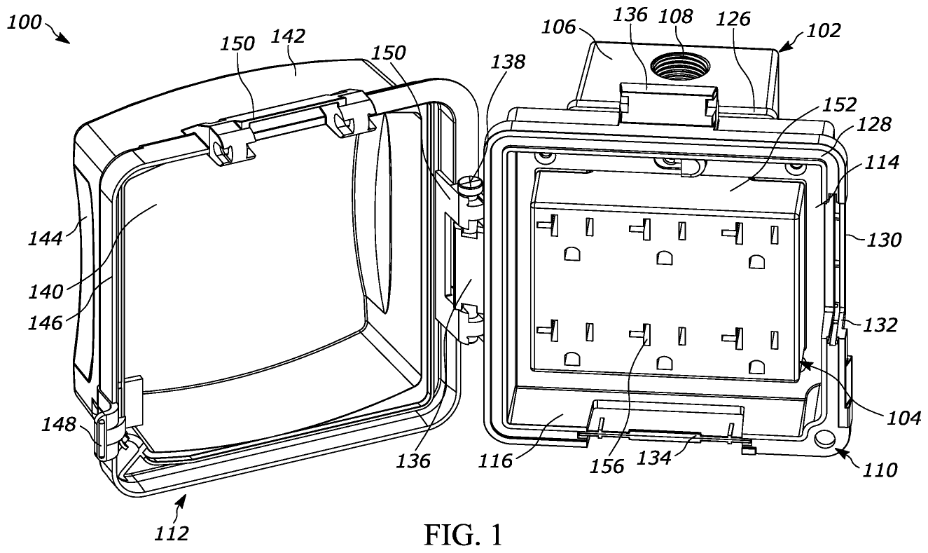

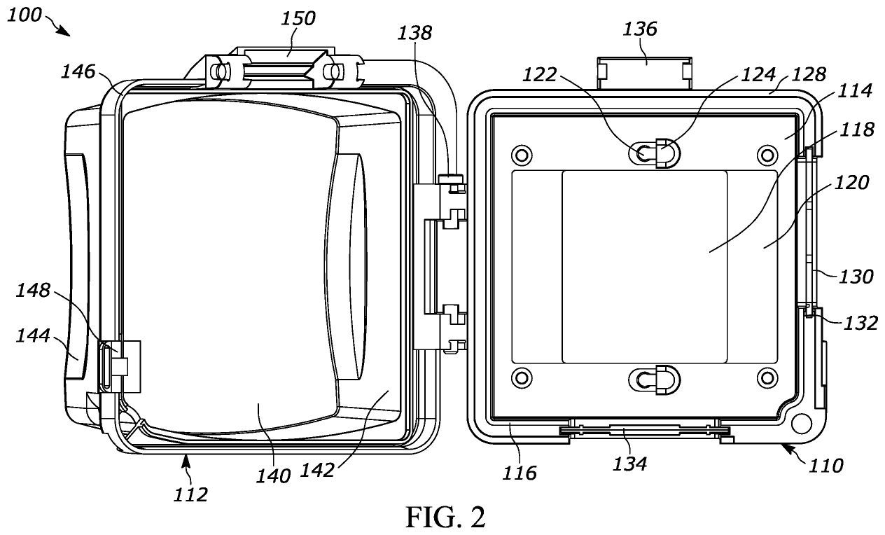

FIGS. 1 and 2 show an exemplary configuration of a cover assembly 100 connected to a receptacle housing 102 to surround a receptacle 104. The receptacle housing 102 can be a standard single-gang housing which is mounted to a support such as a wall or post. The housing 102 can also be mounted within a wall structure so that the front edge of the housing 102 is aligned with the outer surface of a wall. The housing 102 includes a plurality of walls 106 defining an interior cavity. One or more apertures 108 are provided in the walls 106 to allow for a threaded conduit to be connected to the housing. For example, an aperture 108 can be provided in each of the walls 106 and covered by a plug or knockout when not in use. Electrical wiring can be run through the aperture 108 and connected to an electrical receptacle 104 connected to the housing 102.

In certain configurations, the cover assembly 100 includes a base 110 and a cover 112 connected to the base. As best shown in FIGS. 1 and 2, the base 110 can include a back wall 114 and a plurality of base side walls 116 that extend from the back wall 114. The back wall 114 can define a central opening 118 configured to receive a portion of the receptacle 104. The back wall 114 can also include a recessed area 120 surrounding the central opening 118 to receive a portion of the receptacle 104. The central opening 118 can be sized to receive a single-gang receptacle and therefore correspond in size with a front opening of the receptacle housing 102.

The base 110 can also include one or more fastener openings 122 configured to receive a fastener to connect the base 110 to the receptacle housing 102. The fastener openings can be a keyhole slot 122 and one or more keyhole covers 124 or plugs can be provided to help prevent ingress of water or debris through the keyhole slot 122. Different mounting features can also be provided. A gasket 126 can be positioned between the base 110 and the receptacle housing 102 to help prevent ingress of water or debris between the interface of the base 110 and the receptacle housing 102.

The side walls 116 extend from the back wall 114 and can have a height to accommodate electrical plugs and wires enclosed by the cover assembly 100. The side walls 116 can include a flange 128 that defines the outer edge of the side walls 116 to help form a better seal with the cover 112. In certain configurations, one or more passages 130 can be provided in one or more of the side walls 116. The passages 130 can allow for a cord to extend through the cover assembly 100 when the cover 112 is in a closed position. In the illustrated embodiment a first passage 130 is provided in a first side wall 116 and a second passage 130 is provided in a second side wall 116. The first and second passages 130 can be positioned in adjacent side walls 116 and be oriented perpendicular to one another.

A slot 132 can be provided in the flange 128 around the passages 130 to allow a removable gate 134 to be positioned in the passage 130. The gate 134 is shown as having a substantially closed configuration that blocks the passage 130. Other configurations can utilize openings in the gate 134 to act as cable guides or provide other features. The gates 134 can be selectively positioned in the passages 130 as required to allow access of cords or block the passages to help prevent ingress of water and debris. The gates 134 can have one or more reinforced portions having a thicker area to provide stability to a user when removing or inserting the gate 134.

In certain configurations, one or more base hinge bodies 136 extend from one or more of the side walls 116. The base hinge bodies 136 are configured to receive a pin 138 to pivotally connect the cover 112 to the base 110. In the illustrated embodiment, a first base hinge body 136 extends from a first side wall 116 and a second base hinge body 136 extends from a second side wall 116. The base hinge bodies 136 can be positioned on adjacent side walls 116 and be oriented perpendicular to one another. The base hinge bodies 136 can also be positioned opposite the passages 130.

In certain configurations, the cover 112 can include a front wall 140 and a plurality of cover side walls 142 that extend form the front wall 140. A pair of depressions 144 can extend into the side walls 142 to assist a user in grasping the cover 112. The side walls 142 can include a flange 146 that defines an outer edge of the side walls 142 and is configured to surround the base 110. A latch 148 can extend from one or more of the side walls 142 to help secure the cover 112 to the base 110.

In certain configurations, one or more cover hinge bodies 150 can extend from one or more of the side walls 142. The cover hinge bodies 150 are configured to receive a pin 138 to pivotally connect the cover 112 to the base 110. In the illustrated embodiment, a first cover hinge body 150 extends from a first side wall 142 and a second cover hinge body 150 extends from a second side wall 142. The cover hinge bodies 150 can be positioned on adjacent side walls 142 and be oriented perpendicular to one another. A user can selectively orient the cover 112 in either a horizontal or vertical orientation by selectively connecting one of the cover hinge bodies 150 to the respective base hinge body 136 and slidably engaging the pin 138 with the base and cover hinge bodies 136, 150.

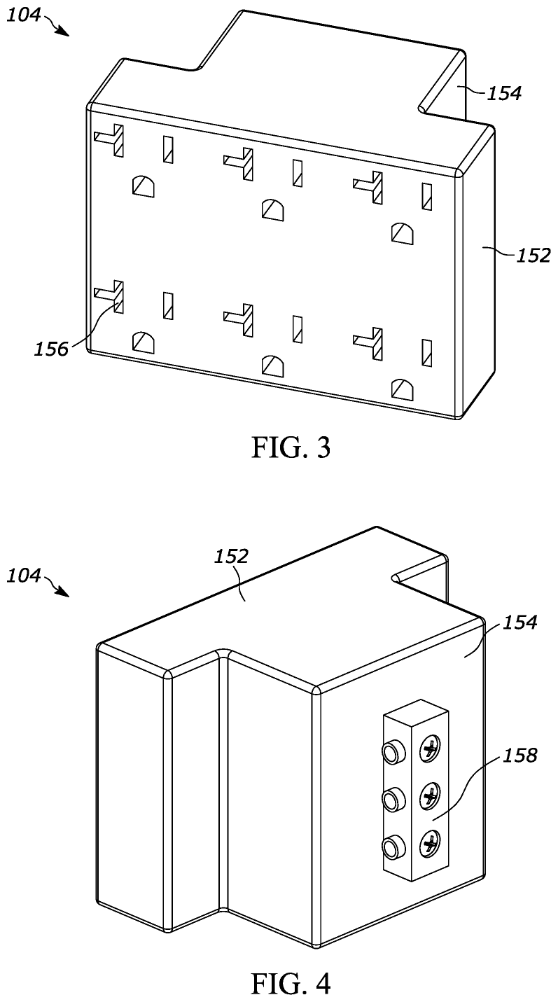

In certain configurations, the receptacle 104 includes a front section 152 and a rear section 154 as best shown in FIGS. 3 and 4. The front section 152 can be wider than the rear section 154 to provide a substantially T-shaped configuration. The front section 152 can be configured to be set in the recess 120 of the back wall 114 of the base 110. The front section 152 includes a set of outlets 156. In the illustrated embodiment shown in FIGS. 3 and 4, six outlets 156 are provided, although fewer or more outlets 156 can be used. The illustrated embodiment shows three-prong outlets, but other types of outlets, including two-prong, USB, pin and sleeve outlets, or other outlets depending on use and various standards for providing power. The receptacle can also include fault detection circuits and mechanisms, such as standard GFCI outlets.

The rear section 154 is configured to extend into the central opening 118 of the base 110 and can extend at least partially into the receptacle housing 102. A set of terminals 158 can be provided on the rear section 154 to allow for an electrical connection to be made to the receptacle 104 to provide power to the outlets 156. The illustrated embodiment shows three terminal connections 158 which can provide power to the six outlets 156 in sets of two.

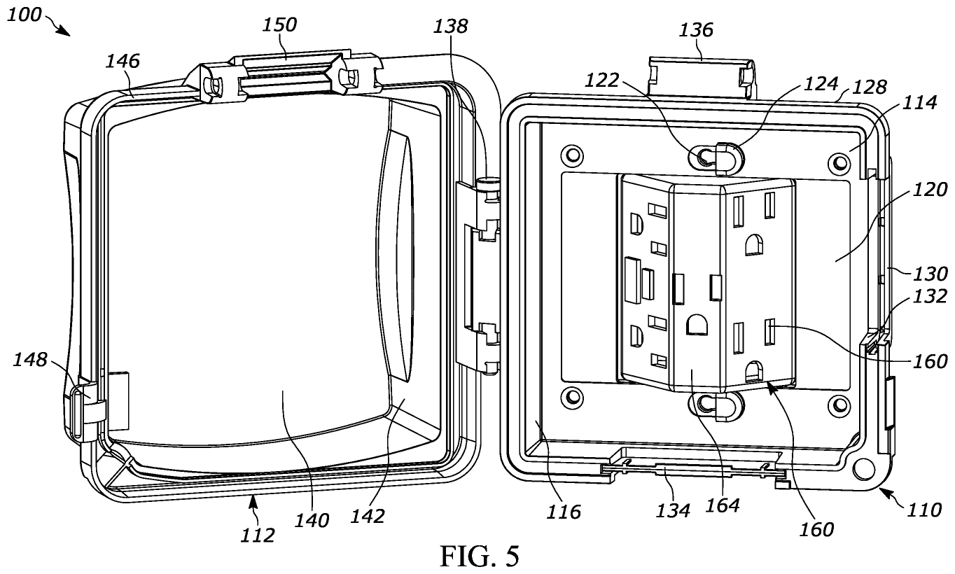

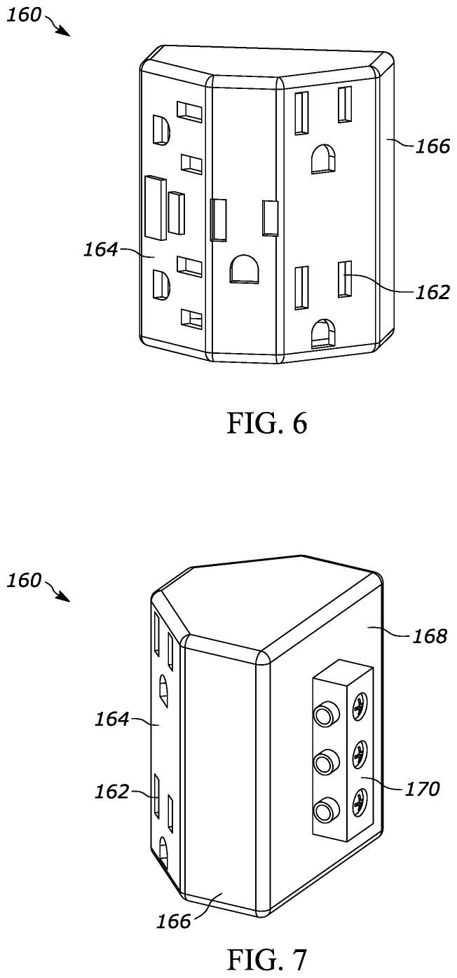

FIGS. 5-7 show another configuration of the receptacle 160 with five outlets 162. The receptacle body has a front section and a rear section with a hexagon configuration. The receptacle 160 can have three front surfaces 164, two side surfaces 166, and a rear surface 168. One or more outlets 162 are provided on each of the front surfaces 164. A set of terminals 170 can be provided on the rear surface 168 to allow for an electrical connection to be made to the receptacle 160 to provide power to the outlets 162. The illustrated embodiment shows three terminal connections 170. Different types of outlets can be used with the receptacle 160, including low voltage outlets, such as USB outlets.

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings.

What is claimed:

1. A cover assembly for a receptacle comprising:
a base having a back wall and a plurality of sidewalls extending from the back wall, wherein a central opening is provided in the back wall, the central opening corresponding in size to a single-gang receptacle housing;
a receptacle connected to the base, the receptacle having a front section with a plurality of outlets and a rear section extending through the central opening, the rear section including a terminal for making an electrical connection to a power supply; and
a cover connected to the base, the cover being pivotable between an open position providing access to the receptacle and a closed position enclosing the receptacle.

2. The cover assembly of claim 1, wherein the receptacle includes at least three outlets.

3. The cover assembly of claim 1, wherein the back wall of the base has a recessed area surround the central opening configured to receive the front section of the receptacle.

4. The cover assembly of claim 1, wherein the front section of the receptacle is wider than the central opening in the base.

5. The cover assembly of claim 1, wherein the receptacle includes a first front face having a first outlet and a second front face having a second outlet, wherein first front face is oriented at an oblique angle relative to the second front face.

6. The cover assembly of claim 1, wherein the base includes a keyhole slot and a keyhole cover.

7. The cover assembly of claim 1, wherein a flange defines an outer edge of the base side walls.

8. The cover assembly of claim 1, wherein the cover is configured to be connected to the base in a vertical orientation or a horizontal orientation.

9. The cover assembly of claim 1, wherein the cover is connected to the base by a removable pin.

10. The cover assembly of claim 1, wherein at least one of the outlets is a three-prong outlets.

11. The cover assembly of claim 1, wherein the base side walls include a first passage and a second passage, and wherein a gate is removably positioned in the first passage and the second passage.

12. A cover assembly for a receptacle comprising:
a base having a back wall and a plurality of sidewalls extending from the back wall, wherein a central opening is provided in the back wall, the central opening corresponding in size to a single-gang receptacle housing;
a receptacle connected to the base, the receptacle having a front section with a multi-gang configuration and a rear section extending through the central opening, the rear section including a terminal for making an electrical connection to a power supply; and
a cover connected to the base, the cover being pivotable between an open position providing access to the receptacle and a closed position enclosing the receptacle.

13. The cover assembly of claim 12, wherein the back wall of the base has a recessed area surround the central opening configured to receive the front section of the receptacle.

14. The cover assembly of claim 12, wherein the front section of the receptacle is wider than the central opening in the base.

15. The cover assembly of claim 12, wherein the receptacle includes a first front face having a first outlet and a second front face having a second outlet, wherein first front face is oriented at an oblique angle relative to the second front face.

16. A cover assembly for a receptacle comprising:
a base having a back wall and a plurality of sidewalls extending from the back wall, wherein a central opening is provided in the back wall, the central opening corresponding in size to a single-gang receptacle housing, and wherein at least one of the plurality of sidewalls includes a first passage;
a gate removably positioned in the first passage;
a receptacle connected to the base, the receptacle having a front section with a plurality of outlets and a rear section extending through the central opening, the rear section including a terminal for making an electrical connection to a power supply; and
a cover connected to the base, the cover being pivotable between an open position providing access to the receptacle and a closed position enclosing the receptacle.

17. The cover assembly of claim 16, wherein the back wall of the base has a recessed area surround the central opening configured to receive the front section of the receptacle.

18. The cover assembly of claim 16, wherein the front section of the receptacle is wider than the central opening in the base.

19. The cover assembly of claim 16, wherein the cover is configured to selectively connect to the base in a first orientation and a second orientation.

20. The cover assembly of claim 16, wherein the front section of the receptacle has a three-gang configuration.
